(19) United States
(12) Patent Application Publication
(10) Pub. No.: US 2023/0230142 A1
(43) Pub. Date: Jul. 20, 2023

(54) RECOMMENDATION CONTROL DEVICE, SYSTEM, METHOD, AND NON-TRANSITORY COMPUTER-READABLE MEDIUM HAVING PROGRAM STORED THEREON

(71) Applicant: NEC Corporation, Minato-ku, Tokyo (JP)

(72) Inventors: Miki OTANI, Tokyo (JP); Honami YUKI, Tokyo (JP)

(73) Assignee: NEC Corporation, Minato-ku, Tokyo (JP)

(21) Appl. No.: 17/801,656

(22) PCT Filed: Mar. 11, 2020
(86) PCT No.: PCT/JP2020/010490

§ 371 Date: Mar. 14, 2023

(51) Int. Cl. G06Q 30/0601

(52) U.S. Cl. CPC G06Q 30/0631

(57) ABSTRACT

Provided is a recommendation control device that provides recommendation information acquired by adding a change to individual's preference. There included an acquisition unit (130) that acquires a captured image photographed by a predetermined photographing device, an authentication control unit (140) that extracts a face region or face feature information from the captured image and causes an authentication device to execute face authentication, a determination unit (150) that determines whether an action history associated with a user ID of a first user who succeeds in the face authentication shows a first tendency, a specification unit (160) that specifies a second user having at least one of an action history and an attribute that is similar to those of the first user when it is determined that the predetermined tendency is shown, and specifies recommendation information, based on a part of an action history of the second user, the part not overlapping with the action history of the first user, and an output unit (170) that transmits, to a predetermined display terminal, the recommendation information specified by the specification means.

### TECHNICAL FIELD

The present invention relates to a recommendation control device, a system, a method, and a non-transitory computer-readable medium storing a program, and more particularly, to a recommendation control device, a system, a method, and a non-transitory computer-readable medium storing a program that provide a user with recommendation information.

### BACKGROUND ART

Patent Literature 1 discloses a technique of presenting a recommended item to a target person by comparing a face image of the target person with an authentication face image of a registered person, and estimating preference of the target person, based on a purchase history or the like of a person who has similarity to the target person once the target person is determined to be the registered person.

### CITATION LIST

### Patent Literature

[Patent Literature 1]

Japanese Unexamined Patent Application Publication No. 2017-224050

### SUMMARY OF INVENTION

### Technical Problem

When, as in the technique disclosed in Patent Literature 1, recommendation information is presented based on an action history on another person who has similar preference to an individual, only items close to the individual's preference are recommended, which may cause a problem of obsolescence.

The present disclosure has been made in order to solve the problem described above, and an object thereof is to provide a recommendation control device, a system, a method, and a non-transitory computer-readable medium storing a program, for providing recommendation information acquired by adding a change to individual's preference.

### Solution to Problem

A recommendation control device according to the present disclosure includes: an acquisition unit configured to acquire a captured image photographed by a predetermined photographing device; an authentication control unit configured to extract a face region or face feature information from the captured image and cause an authentication device to execute face authentication; a determination unit configured to determine whether an action history of a first user who succeeds in the face authentication shows a predetermined tendency; a specification unit configured to specify a second user having at least one of an action history and an attribute that is similar to those of the first user when it is determined that the predetermined tendency is shown, and specify recommendation information, based on, among an action history of the second user, a part not overlapping with the action history of the first user; and an output unit configured to transmit, to a predetermined display terminal, the recommendation information specified by the specification unit.

A recommendation control system according to the present disclosure includes: a photographing device configured to capture an image including a face region of a user; an authentication device configured to store face feature information about the user; and a recommendation control device being connected to the photographing device and the authentication device, wherein the recommendation control system further includes: an acquisition unit configured to acquire a captured image photographed by the photographing device; an authentication control unit configured to extract a face region or face feature information from the captured image and cause an authentication device to execute face authentication; a determination unit configured to determine whether an action history of a first user who succeeds in the face authentication shows a predetermined tendency; a specification unit configured to specify a second user having at least one of an action history and an attribute that is similar to those of the first user when it is determined that the predetermined tendency is shown, and specify recommendation information, based on, among an action history of the second user, a part not overlapping with the action history of the first user; and an output unit configured to transmit, to a predetermined display terminal, the recommendation information specified by the specification unit.

A recommendation control method according to the present disclosure includes: a step of acquiring a captured image photographed by a predetermined photographing device; a step of extracting a face region or face feature information from the captured image and causing an authentication device to execute face authentication; a step of determining whether an action history of a first user who succeeds in the face authentication shows a predetermined tendency; a step of specifying a second user having at least one of an action history and an attribute that is similar to those of the first user when it is determined that the predetermined tendency is shown, and specifying recommendation information, based on, among an action history of the second user, a part not overlapping with the action history of the first user; and a step of outputting, to a predetermined display terminal, the recommendation information that is specified.

A non-transitory computer-readable medium according to the present disclosure records a program causing executing: a step of acquiring a captured image photographed by a predetermined photographing device; a step of extracting a face region or face feature information from the captured image and causing an authentication device to execute face authentication; a step of determining whether an action history of a first user who succeeds in the face authentication shows a predetermined tendency; a step of specifying a second user having at least one of an action history and an attribute that is similar to those of the first user when it is determined that the predetermined tendency is shown, and specifying recommendation information, based on, among an action history of the second user, a part not overlapping with the action history of the first user; and a step of transmitting, to a predetermined display terminal, the recommendation information that is specified.

A recommendation control device according to the present disclosure includes: an acquisition unit configured to acquire a captured image photographed by a predetermined photographing device; an extraction unit configured to extract a face region or face feature information from the captured image; a face authentication unit configured to execute face authentication, based on the face region or the face feature information; a determination unit configured to determine whether an action history of a first user who succeeds in the face authentication shows a predetermined tendency; a specification unit configured to specify a second user having at least one of an action history and an attribute that is similar to those of the first user when it is determined that the predetermined tendency is shown, and specify recommendation information, based on, among an action history of the second user, a part not overlapping with the action history of the first user; and an output unit configured to transmit, to a predetermined display terminal, the recommendation information specified by the specification unit.

A recommendation control method according to the present disclosure includes: a step of acquiring a captured image photographed by a predetermined photographing device; a step of extracting a face region or face feature information from the captured image; a step of executing face authentication, based on the face region or the face feature information; a step of determining whether an action history of a first user who succeeds in the face authentication shows a predetermined tendency; a step of specifying a second user having at least one of an action history and an attribute that is similar to those of the first user when it is determined that the predetermined tendency is shown, and specifying recommendation information, based on, among an action history of the second user, a part not overlapping with the action history of the first user; and a step of transmitting, to a predetermined display terminal, the recommendation information that is specified.

A non-transitory computer-readable medium according to the present disclosure records a program causing executing: a step of acquiring a captured image photographed by a predetermined photographing device; a step of extracting a face region or face feature information from the captured image; a step of executing face authentication, based on the face region or the face feature information; a step of determining whether an action history of a first user who succeeds in the face authentication shows a predetermined tendency; a step of specifying a second user having at least one of an action history and an attribute that is similar to those of the first user when it is determined that the predetermined tendency is shown, and specifying recommendation information, based on, among an action history of the second user, a part not overlapping with the action history of the first user; and a step of transmitting, to a predetermined display terminal, the recommendation information that is specified.

### Advantageous Effects of Invention

According to the present disclosure, it is possible to provide the recommendation control device, the system, the method, and the non-transitory computer-readable medium storing a program, for providing recommendation information acquired by adding a change to individual's preference.

### BRIEF DESCRIPTION OF DRAWINGS

FIG. 1 is a block diagram illustrating a configuration of a recommendation control device according to a first example embodiment;

FIG. 2 is a flowchart illustrating a flow of a recommendation control method according to the first example embodiment;

FIG. 3 is a block diagram illustrating a configuration of a recommendation control system according to a second example embodiment;

FIG. 4 is a block diagram illustrating a configuration of an authentication device;

FIG. 5 is a block diagram illustrating a configuration of the authentication device;

FIG. 6 is a block diagram illustrating a configuration of a user terminal;

FIG. 7 is a flowchart illustrating a flow of face feature information registration processing;

FIG. 8 is a flowchart illustrating a flow of face authentication processing;

FIG. 9 is a flowchart illustrating a flow of history registration processing;

FIG. 10 is a flowchart illustrating a flow of recommendation control processing;

FIG. 11 is a flowchart illustrating a flow of recommendation information specification processing;

FIG. 12 is a flowchart illustrating a flow of recommendation request processing;

FIG. 13 is a diagram exemplifying recommendation information displayed on a display terminal;

FIG. 14 is a diagram exemplifying a map displayed on the display terminal;

FIG. 15 is a diagram exemplifying an action history displayed on the display terminal;

FIG. 16 is a block diagram illustrating a configuration of a recommendation control device according to a third example embodiment; and

FIG. 17 is a block diagram illustrating a configuration of the recommendation control device according to the third example embodiment.

### EXAMPLE EMBODIMENT

With reference to the drawings, example embodiments of the present disclosure are described below in detail. In each of the drawings, the same or associated elements are denoted with the same reference symbols, and redundant description is omitted as appropriate for clarity of the description.

### First Example Embodiment

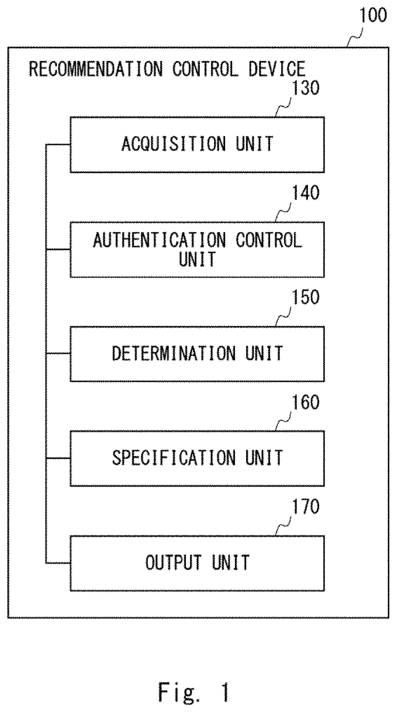

FIG. 1 is a block diagram illustrating a configuration of a recommendation control device 100 according to a first example embodiment. The recommendation control device 100 includes an acquisition unit 130, an authentication control unit 140, a determination unit 150, a specification unit 160, and an output unit 170. The recommendation control device 100 is connected to a network 500 (not illustrated). The network 500 may be wired or may be wireless. An authentication device 200 and a face authentication terminal 300 that are not illustrated are connected to the network 500.

The acquisition unit 130 acquires a captured image that is photographed by a predetermined photographing device. For example, the predetermined photographing device is a camera included in the face authentication terminal 300, or a camera of a user terminal owned by a user, such as a smartphone. The authentication control unit 140 extracts a face region or face feature information from the captured image, and causes the authentication device 200 to execute face authentication. The authentication device 200 stores in advance a user ID and the face feature information about the user in association with each other. In the following description, a user succeeding in face authentication is referred to as a first user in some cases.

The determination unit 150 determines whether an action history of the first user succeeding in face authentication shows a predetermined tendency. When it is determined that the action history of the first user has the predetermined tendency, the specification unit 160 specifies a second user having at least one of an action history and an attribute that are similar to those of the first user, and specifies recommendation information, based on a part of the action history of the second user, which does not overlap with the action history of the first user. The output unit 170 transmits, to a predetermined display terminal, the recommendation information specified by the specification unit 160.

For example, the predetermined display terminal is the face authentication terminal 300, a user terminal, a shop terminal, and a street signage. The user terminal is a communication device owned by a user, such as a smartphone. The shop terminal is a terminal installed in each shop, and displays “How about going to XX, next?” when a user leaves the shop, for example. The predetermined display terminal may be the above-mentioned predetermined photographing device, or may be a different terminal. For example, when the captured image is photographed by the user terminal, the output unit 170 may transmit the recommendation information to the user terminal, or may transmit the recommendation information to the face authentication terminal 300 or the like. When the captured image is photographed by the face authentication terminal 300, the output unit 170 may transmit the recommendation information to the face authentication terminal 300, or may transmit the recommendation information to the user terminal or the like.

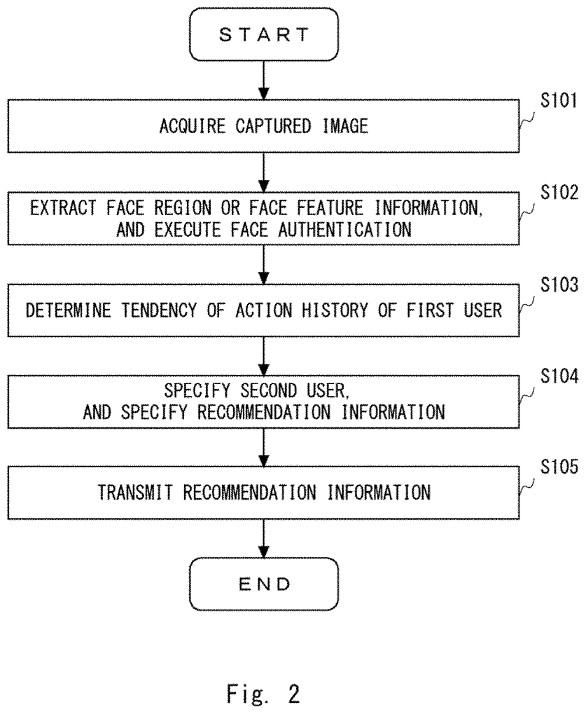

FIG. 2 is a flowchart illustrating a flow of a recommendation control method according to the first example embodiment. First, the acquisition unit 130 acquires a captured image that is photographed by the predetermined photographing device (Step S101). Subsequently, the authentication control unit 140 extracts a face region or face feature information from the captured image acquired by the acquisition unit 130, and causes the authentication device 200 to execute face authentication (Step S102). The authentication device 200 compares the face region or the face feature information that is received from the authentication control unit 140 and the face feature information registered in the authentication device 200, determines success or failure of the authentication, based on presence or absence of matching, and returns a determination result. Note that it is assumed that the authentication device 200 stores the user ID and the face feature information in association with each other. Then, when the authentication device 200 succeeds in face authentication, transmits the determination result including the successfully authenticated user ID.

Subsequently, the determination unit 150 determines the user ID succeeding in the face authentication or the action history associated with the user ID included in a change recommendation request shows the predetermined tendency (Step S103). The change recommendation request is a change request for the recommendation information, and includes the user ID. When it is determined that the action history shows the predetermined tendency, the second user having at least one of the action history and the attribute that are similar to those of the first user is specified, and the recommendation information is specified based on a part of the action history of the second user, which does not overlap with the action history of the first user (Step S104). Subsequently, the output unit 170 transmits, to the predetermined display terminal, the recommendation information specified by the specification unit 160 (Step S105). In this manner, with the recommendation control method according to the present example embodiment, the recommendation information acquired by adding a change to individual's preference can be provided.

In addition to the configuration illustrated in FIG. 1, the recommendation control device 100 may include configurations such as a history storage unit and a history registration unit.

The history storage unit stores an action history of a user. The action history is a history of action contents performed by the user when face authentication succeeds, and is a purchase history of products, an entry/exit record of a building, a participation record for an event, or the like. The action history may include information relating to a time at which the user takes an action. The history registration unit registers the user ID and the action history in association with each other in the history storage unit. Prior to Step S101 in FIG. 2, the history registration unit registers the user ID and the action history in association with each other in the history storage unit. The determination unit 150 acquires, from a history storage means, the action history associated with the user ID of the first user succeeding in the face authentication, and determines whether the action history shows the predetermined tendency.

Note that the recommendation control device 100 includes a processor, a memory, and a storage device, as a configuration not illustrated. Further, the storage device stores a computer program implemented for processing of the recommendation control method according to the present example embodiment. Further, the processor causes the memory to read the computer program from the storage device, and executes the computer program. With this, the processor achieves the functions of the history registration unit, the acquisition unit 130, the authentication control unit 140, the determination unit 150, the specification unit 160, and the output unit 170.

Alternatively, the history registration unit, the acquisition unit 130, the authentication control unit 140, the determination unit, the specification unit 160, and the output unit 170 may each be made of dedicated hardware. Further, a part or all of each component of each device may be made up of general-purpose or dedicated circuitry, a processor, and the like, or a combination thereof. Those may be composed of a single chip or may be composed of a plurality of chips connected to each other via a bus. A part or all of each component of each device may be made up of a combination of the above-described circuitry and the like and a program. Further, as the processor, a Central Processing Unit (CPU), a Graphics Processing Unit (GPU), a Field-Programmable Gate Array (FPGA), or the like can be used.

Further, when a part or all of each component of the recommendation control device 100 is made up of a plurality of information processing devices, circuitry, and the like, the plurality of information processing devices, the circuitry, and the like may be arranged in a centralized manner, or may be arranged in a distributed manner. For example, the information processing devices, the circuitry, and the like may be constructed as a form in which those are connected with each other via a communication network, such as a client server system or a cloud computing system. Further, the functions of the recommendation control device 100 may be provided in a form of Software as a Service (SaaS).

### Second Example Embodiment

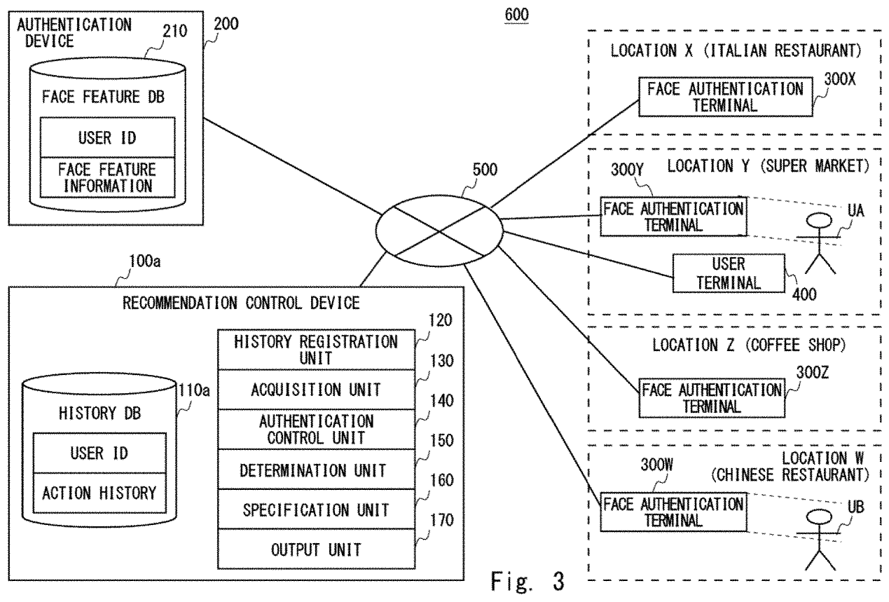

A second example embodiment is a specific example of the first example embodiment described above. FIG. 3 is a block diagram illustrating a configuration of a recommendation control system 600 according to the second example embodiment. The recommendation control system 600 includes at least the recommendation control device 100a and the authentication device 200, and further includes at least one of the face authentication terminal 300 and a user terminal 400. The recommendation control device 100a, the authentication device 200, the face authentication terminals 300 (300X, 300Y, 300Z, and 300W), and the user terminal 400 are connected to each other via the network 500. Note that description overlapping with the first example embodiment is omitted as appropriate.

The recommendation control device 100a includes a history database (DB) 110a, a history registration unit 120, the acquisition unit 130, the authentication control unit 140, the determination unit 150, the specification unit 160, and the output unit 170. The recommendation control device 100a is a device that performs accumulation of the action history, specification of the recommendation information from the captured image, and output thereof, and is a server device made of a computer, for example.

The history DB 110a is a database for accumulating an action history of a user. The history DB 110a stores the user ID and the action history of the user in association with each other. For example, the action history includes a purchase history of the user. The history registration unit 120 receives a history registration request from the face authentication terminal 300 or the user terminal 400 via the network 500, and registers the user ID included in the history registration request, a passing point, and the action history in association with each other in the history DB 110a.

The acquisition unit 130 receives a face authentication request, the history registration request, and the change recommendation request from the face authentication terminal 300 or the user terminal 400 via the network 500. In other words, the acquisition unit 130 acquires an image captured by a camera 310 or 410, installation position information relating to the camera 310 or 410 (hereinafter, simply referred to as an “installation position”), and the like, from the face authentication terminal 300 or the user terminal 400.

The authentication control unit 140 extracts a face region or face feature information from an authentication image included in the face authentication request, transmits the face region or the face feature information to the authentication device 200, and causes face authentication to be executed. Further, the authentication control unit 140 receives success or failure of the face authentication from the authentication device 200, and returns the face authentication result to the terminal being a request source. Note that when the face authentication succeeds, the face authentication result includes the user ID.

The determination unit 150 acquires, from the history DB 110a, the action history associated with the user ID of the user succeeding in the face authentication (the first user). The determination unit 150 analyzes the acquired action history, and determines whether the resultant shows the predetermined tendency. Here, for example, the predetermined tendency indicates that a similar action is performed for the specified number of times or more or is continuously performed within a predetermined period. Further, for example, the similar action has an action content that includes a character string indicating a common location, content, or the like, specifically, indicating purchase of a specific product or the like.

When the determination unit 150 determines that the predetermined tendency is shown, the specification unit 160 specifies the second user. The second user is a user who has an action history similar to the action history of the first user, which shows the predetermined tendency. Specifically, for example, the specification unit 160 specifies the user ID having an action history including the same character string as a predetermined action included in the action history of the first user. Note that the second user may be a user having an attribute similar to that of the first user. Subsequently, the specification unit 160 specifies an action history in the action history of the second user, which does not overlap with the predetermined tendency. For example, the specification unit 160 extracts an action history in the action history of the second user, which does not include the above-mentioned character string. Further, the specification unit 160 specifies, from the extracted action history, an action history performed for the specified number of time or more or an action history performed continuously within a predetermined period.

Subsequently, the specification unit 160 specifies the recommendation information, based on the specified action history. Here, the recommendation information is information for making recommendation for the user who issues the change recommendation request. For example, the recommendation information is the specified action history itself, that is, a recommended location and content. Alternatively, the recommendation information may include one of a recommended location and content. Further, the recommendation information may be a discount coupon of a shop included in the specified action history. The output unit 170 transmits, via the network 500, the recommendation information specified by the specification unit 160, to the terminal succeeding in the face authentication or the terminal that issues the change recommendation request. The output unit 170 may transmit the recommendation information to a terminal other than the terminals that issues the face authentication and the change recommendation request. For example, when face authentication is executed from the shop terminal, the output unit 170 may transmit the recommendation information to the shop terminal, or may transmit the recommendation information to the user terminal owned by the user succeeding in the face authentication.

The authentication device 200 is a device that executes face authentication for a user. The authentication device 200 includes a face feature DB 210. The face feature DB 210 is a face feature database that stores the user ID and the face feature information on the user in association with each other. Note that the face feature DB 210 is one example of a face feature information storage unit. The face authentication terminal 300 is a terminal that captures an image to be used for face authentication. The face authentication terminal 300 is a terminal that transmits the captured image to the recommendation control device 100a and issues the face authentication request. The face authentication terminal 300 is installed at each of locations X, Y, Z, and W (hereinafter, referred to as “locations X to W”). Specifically, a face authentication terminal 300X is installed at the location X, a face authentication terminal 300Y is installed at the location Y, a face authentication terminal 300Z is installed at the location Z, and a face authentication terminal 300W is installed at the location W. At the time of visiting the locations X to W, a user faces the cameras of the installed face authentication terminals 300X to 300W for photographing, and performs purchase of a product or the like at the locations.

The user terminal 400 is a terminal owned by a user. The user terminal 400 is a communication terminal such as a smartphone, a tablet, and a PC. A user utilizes the face authentication terminal 300 or the user terminal 400, and acquires an image including a face of the user. The face authentication terminal 300 or the user terminal 400 transmits the captured image to the recommendation control device 100a.

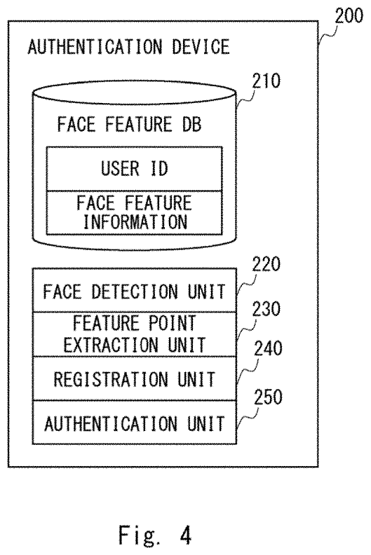

Next, with reference to FIG. 4, a configuration of the authentication device 200 is described in detail. FIG. 4 is a block diagram illustrating the configuration of the authentication device 200. The authentication device 200 includes the face feature DB 210, a face detection unit 220, a feature point extraction unit 230, a registration unit 240, and an authentication unit 250.

The face feature DB 210 is a face feature data base that stores the user ID and the face feature information about the user in association with each other. The face detection unit 220 detects the face region included in the captured image, and outputs the resultant to the feature point extraction unit 230. The feature point extraction unit 230 extracts a feature point from the face region detected by the face detection unit 220, and outputs the face feature information to the registration unit 240. The face feature information is an assembly of extracted feature points.

When the face feature information is registered, the registration unit 240 issues a new user ID. The registration unit 240 registers the issued user ID and the face feature information extracted from the registered image in association with each other, in the face feature DB 210. The authentication unit 250 executes comparison between the face feature information extracted from the face image and the face feature information in the face feature DB 210. The authentication unit 250 determines that the face authentication succeeds when the face feature information matches, and determines that the face authentication fails when the face feature information does not match. The authentication unit 250 returns success or failure of the face authentication to the recommendation control device 100a. Presence or absence of matching of the face feature information is associated with success or failure of the authentication. Further, the authentication unit 250 specifies the user ID associated with the successful face feature information when the face authentication succeeds, and returns, to the recommendation control device 100a, the authentication result including the specified user ID and success of the authentication.

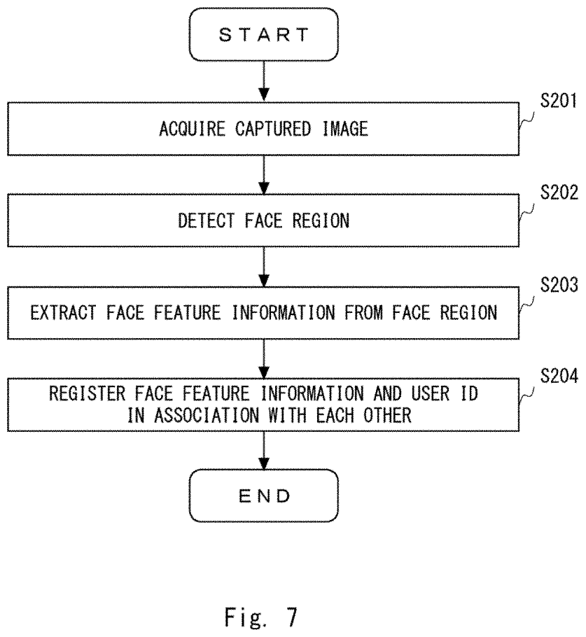

With reference to FIG. 7, description is made on an operation of the authentication device 200 when the user ID and the face feature information are registered in the face feature DB 210. FIG. 7 is a flowchart illustrating a flow of face feature information registration processing. In FIG. 7, description is made on a case in which the face authentication terminal 300 captures an image and registers face feature information, but the face feature information can be registered by following a similar procedure even when the user terminal 400 captures an image.

When the face feature information is registered, the face authentication terminal 300 captures an image including a user's face as a registration image, and issues a face feature information registration request with respect to the authentication device 200 via the network 500. The face feature information registration request includes the registration image. First, the authentication device 200 acquires the registration image from the face authentication terminal 300 or the user terminal 400 via the network 500 (Step S201).

Subsequently, the face detection unit 220 detects the face region included in the registration image (Step S202), and outputs the detected face region to the feature point extraction unit 230. Subsequently, the feature point extraction unit 230 extracts a feature point from the face region, and outputs the face feature information to the registration unit 240 (Step S203). Subsequently, the registration unit 240 issues a user ID associated with the output face feature information, and registers the user ID and the face feature information in association with each other in the face feature DB 210 (Step S204).

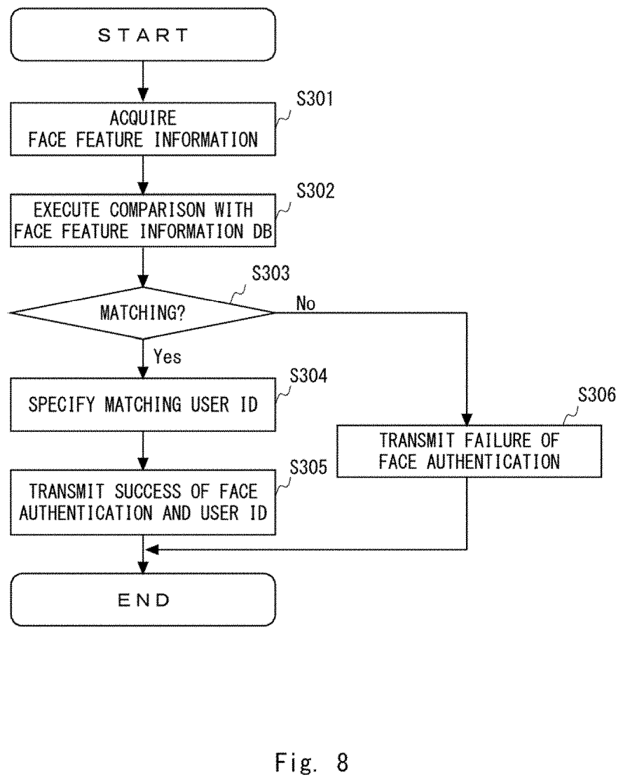

With reference to FIG. 8, description is made on an operation of the authentication device 200 when face authentication is executed. FIG. 8 is a flowchart illustrating a flow of face authentication processing. In FIG. 8, description is made on a case in which the face authentication terminal 300 issues the face authentication request, but the face authentication can be executed by following a similar procedure even when the user terminal 400 executes the face authentication request.

When face authentication is executed, the face authentication terminal 300 captures an image including a user's face as an authentication image, and issues the face authentication request to the recommendation control device 100a via the network 500. The face authentication request includes the authentication image. First, the recommendation control device 100a transmits the face region or the face feature information, which is extracted from the authentication image, to the authentication device 200. The feature point extraction unit 230 extracts the face feature information from the received face region, or acquires the face feature information by receiving the face feature information (Step S301).

Subsequently, the authentication unit 250 execution comparison between the face feature information acquired by the acquisition unit 130 and the face feature DB 210 (Step S302). When the face feature information matches (Yes in Step S303), the authentication unit 250 specifies the user ID of the user with which the face feature information matches (Step S304), and returns, to the recommendation control device 100a, success of the face authentication and the specified user ID (Step S305). When there is no matching with the face feature information (No in Step S303), the authentication unit 250 returns failure of the face authentication to the recommendation control device 100a (Step S306).

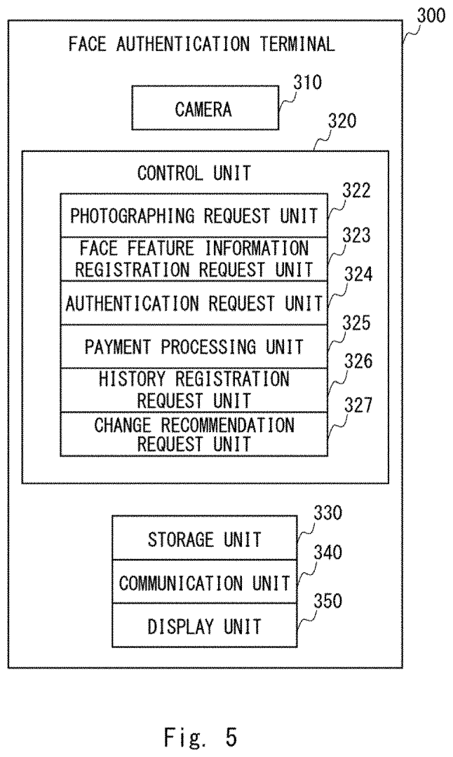

Subsequently, with reference to FIG. 5, a configuration of the face authentication terminal 300 is described in detail. The face authentication terminal 300 includes a photographing device such as a camera, a display device, and computer, as a hardware configuration. The face authentication terminal 300 is a device that issues the face feature information registration request and the face authentication request. Examples of the face authentication terminal 300 include a terminal that executes payment with face authentication, a terminal that executes entry control with face authentication, and a digital signage that provides information according to face authentication, but are not limited thereto.

FIG. 5 is a block diagram illustrating a configuration of the face authentication terminal 300. The face authentication terminal 300 includes the camera 310, a control unit 320, a storage unit 330, a communication unit 340, and a display unit 350. The camera 310 is a photographing device that captures an image. The control unit 320 controls hardware included in the face authentication terminal 300. The control unit 320 includes a photographing request unit 322, a face feature information registration request unit 323, an authentication request unit 324, a payment processing unit 325, a history registration request unit 326, and a change recommendation request unit 327.

The photographing request unit 322 issues a photographing request to the camera 310. The camera 310 captures an image including a user's face. The image captured by the camera 310 is used as the registration image and the authentication image. The face feature information registration request unit 323 transmits the face feature information registration request to the authentication device 200 via the network 500. The face feature information registration request includes the registration image captured by the camera 310. The authentication request unit 324 transmits the face authentication request to the recommendation control device 100a via the network 500. The face authentication request includes the authentication image captured by the camera 310. The authentication request unit 324 receives success or failure of the face authentication from the recommendation control device 100a, and causes the display unit 350 to display the result.

The payment processing unit 325 executes payment processing when face authentication succeeds. Note that the control unit 320 may include a recording unit, which is not illustrated, in place of the payment processing unit 325. When face authentication succeeds, the recording unit records that a user enters or leaves a building in which the face authentication terminal 300 is installed. The history registration request unit 326 transmits the history registration request to the authentication device 200 via the network 500. Note that the history registration request includes payment history being a result of payment processing. For example, the payment history is information including a payment date, a price, an item, a user ID, and the like. The change recommendation request unit 327 transmits the change recommendation request to the recommendation control device 100a via the network 500.

The storage unit 330 is a storage device that stores a program for implementing each of the functions of the face authentication terminal 300. The communication unit 340 is a communication interface with respect to the network 500. The display unit 350 is a display device that displays the face authentication result, the recommendation information, and the like for a user.

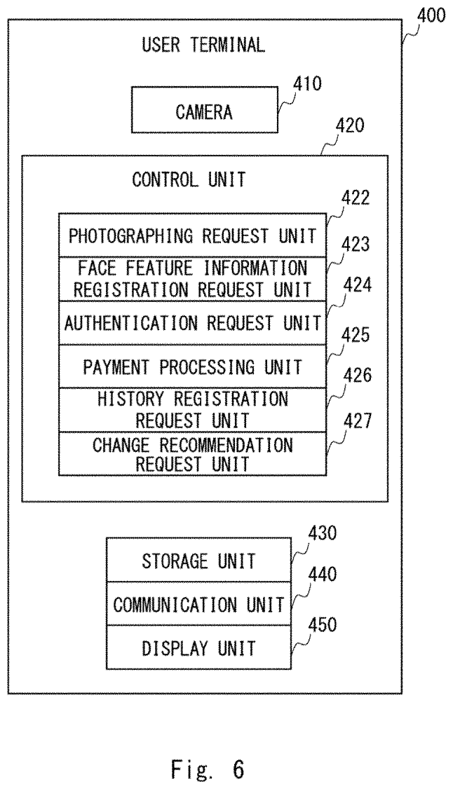

Subsequently, with reference to FIG. 6, a configuration of the user terminal 400 is described in detail. FIG. 6 is a block diagram illustrating the configuration of the user terminal 400. The user terminal 400 includes the camera 410, a control unit 420, a storage unit 430, a communication unit 440, and a display unit 450. The control unit 420 includes a photographing request unit 422, a face feature information registration request unit 423, an authentication request unit 424, a payment processing unit 425, a history registration request unit 426, and a change recommendation request unit 427. A function of each of the configurations included in the user terminal 400 is similar to each of the configurations of the face authentication terminal 300, and hence description therefor is omitted.

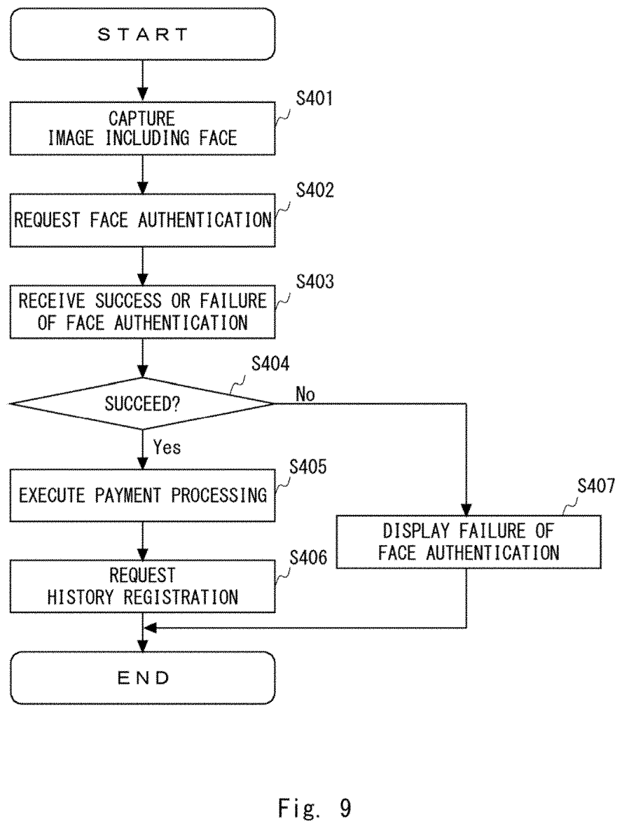

When face authentication succeeds, the face authentication terminal 300 and the user terminal 400 executes payment processing or the like, and issues the history registration request for causing the recommendation control device 100a to register a history thereof. In the following description, with reference to FIG. 9, description is made on an operation of the face authentication terminal 300 when the history registration request is issued. FIG. 9 is a flowchart illustrating a flow of history registration processing. In FIG. 9, description is made on a case in which the face authentication terminal 300 issues the history registration request, but the user terminal 400 can also issue the history registration request by following a similar procedure.

First, the photographing request unit 322 issues a photographing request to the camera 310, and the camera 310 captures an authentication image including a user's face (Step S401). Subsequently, the authentication request unit 324 transmits the face authentication request to the authentication device 200 via the network 500 (Step S402), and receives success or failure thereof from the authentication device 200 (Step S403). When the face authentication succeeds (Yes in Step S404), the payment processing unit 325 executes payment processing (Step S405), and the history registration request unit 326 issues the history registration request to the authentication device 200 via the network 500 (Step S406). When the face authentication fails (No in Step S405), the history registration request unit 326 causes the display unit 350 to display failure of the face authentication.

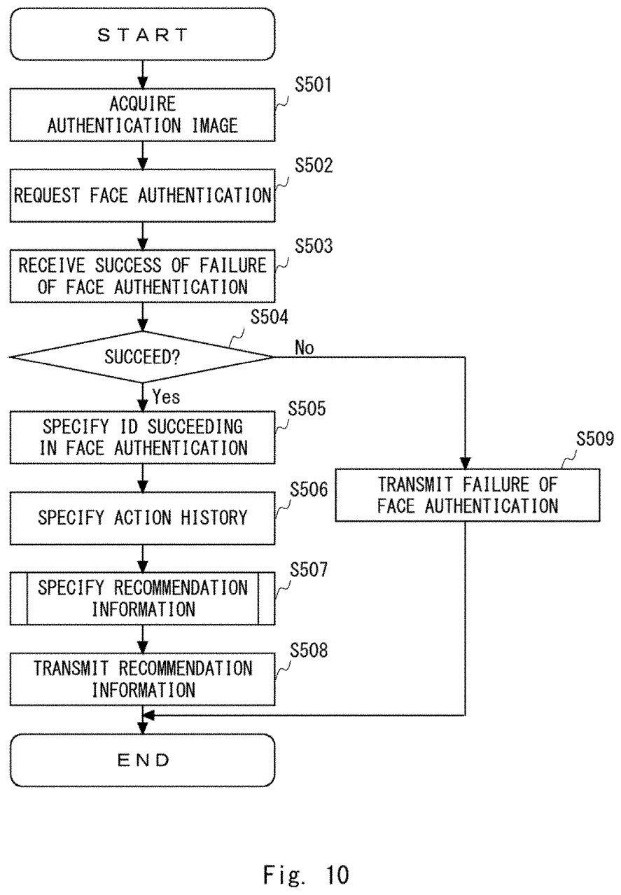

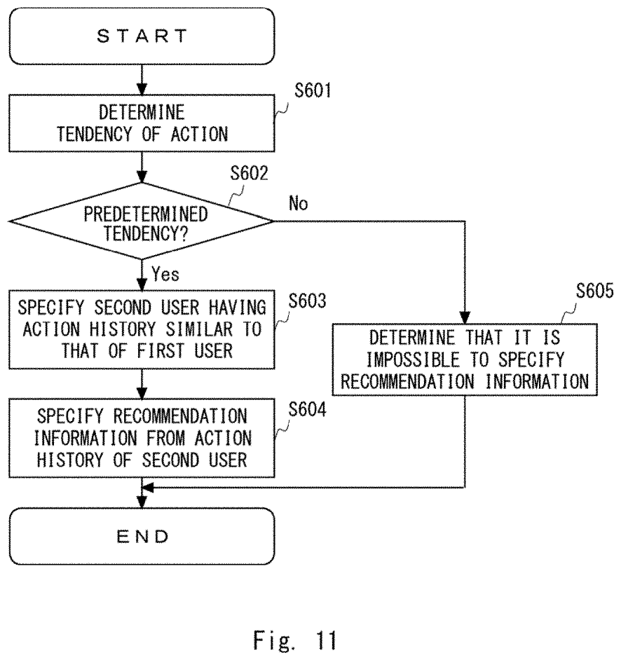

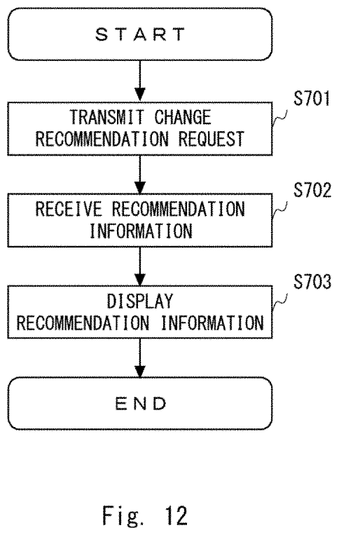

When the face authentication succeeds, or the change recommendation request is received, the recommendation control device 100a provides the recommendation information. In the following description, with reference to FIG. 10 to FIG. 12, description is made on an operation of the recommendation control device 100a and the like when the recommendation information is provided. FIG. 10 is a flowchart illustrating a flow of recommendation control processing. FIG. 11 is a flowchart illustrating a flow of recommendation information specification processing. FIG. 12 is a flowchart illustrating a flow of recommendation request processing.

First, with reference to FIG. 10, description is made on a case in which the recommendation information is provided when the face authentication succeeds. First, the acquisition unit 130 acquires the authentication image captured by the predetermined photographing device of the face authentication terminal 300, the user terminal 400, or the like (Step S501). Note that, at this state, it is assumed that the acquisition unit 130 acquires an installation position of the predetermined photographing device, in addition to the authentication image. Subsequently, the authentication control unit 140 extracts the face region or the face feature information, transmits the face region or the face feature information to the authentication device 200, and requests face authentication (Step S502). Subsequently, the authentication control unit 140 receives success or failure of the face authentication from the authentication device 200 (Step S503).

When the face authentication succeeds (Yes in Step S504), the determination unit 150 extracts the user ID (the user ID of the first user) included in the result indicating success or failure of the face authentication, which is received in Step S503, and thus specifies the user ID succeeding in the face authentication (Step S505). Subsequently, the determination unit 150 acquires, from the history DB 110a, the action history associated with the user ID specified in Step S605, and thus specifies the action history of the first user (Step S506).

The specification unit 160 specifies the recommendation information provided to the first user (Step S507). Subsequently, the output unit 170 transmits the recommendation information, which is specified by the specification unit 160, to the predetermined display terminal of the face authentication terminal 300, the user terminal 400, or the like via the network 500 (Step S509). When the face authentication fails (No in Step S504), the output unit 170 transmits failure of the face authentication the predetermined display terminal via the network 500 (Step S510).

With reference to FIG. 11, the operation of the recommendation control device 100a in Step S507 is descried in detail. First, when the action history of the first user is specified (Step S506), the determination unit 150 determines whether the action history shows the predetermined tendency (Step S601). When the action history shows the predetermined tendency (Yes in Step S602), the specification unit 160 specifies the second user having an action history similar to that of the first user (Step S603). The specification unit 160 may specify, as the second user, a user having an action history showing the predetermined tendency similarly to the first user. With this, a user with an action history showing a more similar tendency can be specified, and recommendation accuracy is further improved. Note that, in Step S603, the specification unit 160 may specify, as the second user, a user having an attribute similar to that of the first user. Example of the attribute include sex, age, a family structure, and the like, and friends on a Social Networking Service (SNS) and the like may be included.

Subsequently, the specification unit 160 specifies an action history in the action history of the second user, which does not overlap with the predetermined tendency, and specifies the recommendation information, based on the specified action history (Step S604). The action history of the first user does not show the predetermined tendency (No in Step S602), the specification unit 160 determines that there is difficulty in specifying the recommendation information (Step S605).

Subsequently, with reference to FIG. 12, description is made on a case in which the recommendation information is provided according to the change recommendation request. When the face authentication succeeds (Yes in Step S404), the face authentication terminal 300 and the user terminal 400 can execute the recommendation request processing (Step S701 to Step S703). The recommendation request processing (Step S701 to Step S703) may be executed simultaneously with the payment processing (Step S405) and the history registration request (Step S406), or may be executed after the history registration request (Step S406). In FIG. 12, description is made on a case in which the face authentication terminal 300 executes provision processing, but the user terminal 400 can also execute the provision processing by following a similar procedure.

First, the change recommendation request unit 327 transmits the change recommendation request to the recommendation control device 100a via the network 500 (Step S701). The recommendation control device 100a receives the change recommendation request, and then specifies and returns the recommendation information by following a similar procedure in Step S505 to Step S508. The change recommendation request unit 327 receives the recommendation information from the recommendation control device 100a (Step S702), and then the display unit 350 displays the recommendation information (Step S703).

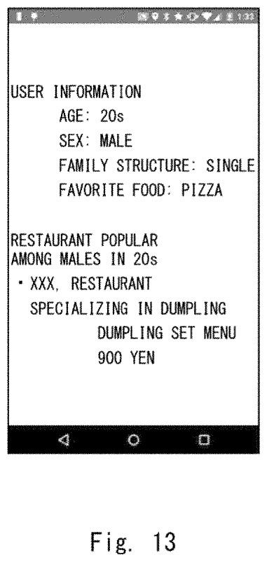

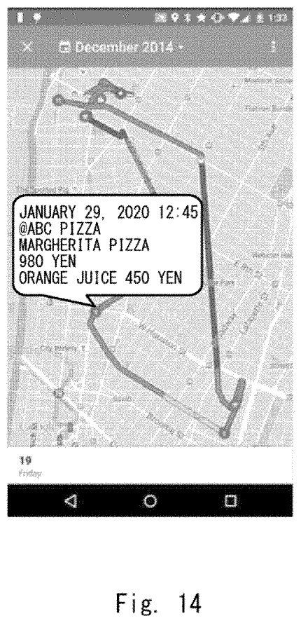

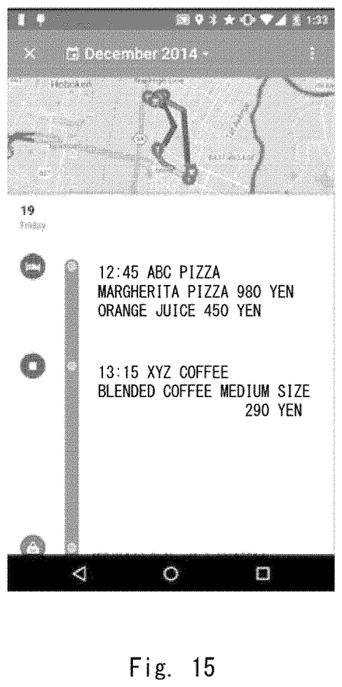

FIG. 13 is a diagram exemplifying the recommendation information displayed on the display terminal. FIG. 13 illustrates a case in which the user terminal 400 displays the recommendation information. As illustrated in FIG. 13, the user terminal 400 displays the recommendation information received in Step S508, on a display screen. Note that, in Step S508, the output unit 170 may transmit the action history of the first user to the user terminal 400, in addition to the recommendation information. FIG. 14 is a diagram exemplifying a map displayed on the display terminal as the action history. As illustrated in FIG. 14, the user terminal 400 may display the action history received in Step S508, on the map. Further, FIG. 15 is a diagram exemplifying the action history displayed on the display terminal. As illustrated in FIG. 15, the user terminal 400 may display the action history received in Step S508, in a chronological manner.

FIG. 14 and FIG. 15 each illustrate a case in which only the action history of the first user is displayed on the display terminal, but the recommendation information may be displayed on the display terminal in addition to the action history. The recommendation information may include shop information, a shop address, route guidance from a current location of a user to a shop, and the like. The route guidance may include a distance and a time required from a current location of a user to a shop. Further, a plurality pieces of recommendation information may be displayed on the display terminal. When the plurality pieces of recommendation information are displayed, details, route guidance, and the like of each piece of the recommendation information may be displayed at the same time. A user is allowed to examine details, route guidance, and the like of each piece of the recommendation information and compare the recommendation information with each other.

A specific example of the recommendation information provided to the first user is described below. For example, the predetermined tendency is regarded as “an action history including three or more entries of a character string “pasta” or a continuous entry thereof for two months or longer”, and “a user with an action history including a character string “pasta”” is regarded as a (second) user with a similar action history. An action history of a user UA is illustrated in Table 1 given below.

TABLE 1

| | | | |
|---|---|---|---|
| Date | Apr. 1, 2019 | May 2, 2019 | Jun. 3, 2019 |
| Location | X | Y | Z |
| Content | Ordering pasta | Purchasing pasta | Ordering pasta |

As illustrated in Table 1, the user UA performs an action including the character string “pasta” for three times, and continues the action for two months or longer. Therefore, the action history of the user UA shows the above-mentioned predetermined tendency. An action history of a user UB different from the user UA is illustrated in Table 2 given below.

TABLE 2

| | | | |
|---|---|---|---|
| Date | Apr. 1, 2019 | May 3, 2019 | Jun. 4, 2019 |
| Location | X | W | Y |
| Content | Ordering pasta | Ordering dumpling | Purchasing dumpling |

As illustrated in Table 2, the user UB performs an action including the character string “pasta”, and hence has an action history similar to that of the user UA. The user UB performs an action including a character string “dumpling” for twice, which does not include the character string “pasta” in the action history. In view of this, “dumpling” is specified as recommendation information and is provided to the user UA, and thus the recommendation information acquired by adding a change to preference of the user UA can be provided. Note that, when the second user is regarded as “a user with an action history showing the predetermined tendency”, the action history of the second user is also required to satisfy the condition that “the action history includes three or more entries of the character string “pasta” or a continuous entry thereof for two months or longer”. For example, a history entry illustrating a date “Jun. 5, 2019”, a location “Y”, and a content “purchasing pasta” is included in Table 2, it can be understood that the action history of the second user also shows the predetermined tendency.

In the specific example given above, the predetermined tendency is regarded as “continuation of a specific action within a predetermined period or longer or performance of the specific action for the predetermined number of times of more”. However, the predetermined tendency is not limited thereto, and may be regarded as “performance of a specific action for the predetermined number of times or more within a predetermined period”, “performance of an action in a specific regional area for the predetermined number of times or more within a predetermined period”, “performance of an action with a specific purchase amount for the predetermined number of times or more within a predetermined period”, or the like.

At the time of specifying a user having a similar action history, an attribute or the like or the first user may be taken into consideration. For example, an attribute such as age, sex, a family structure, and a favorite item is taken into consideration, and thus the second user having preference more similar to that of the first user can be specified. Further, at the time of specifying a user having a similar action history, the second user may be specified among friends of the first user on an SNS.

### Third Example Embodiment

A third example embodiment is a modification of the first example embodiment and the second example embodiment. The recommendation control devices 100 and 100a according to the first example embodiment and the second example embodiment executes face authentication by using the authentication device 200 being an external device. Meanwhile, a recommendation control device 800 according to the present example embodiment executes face authentication inside the device.

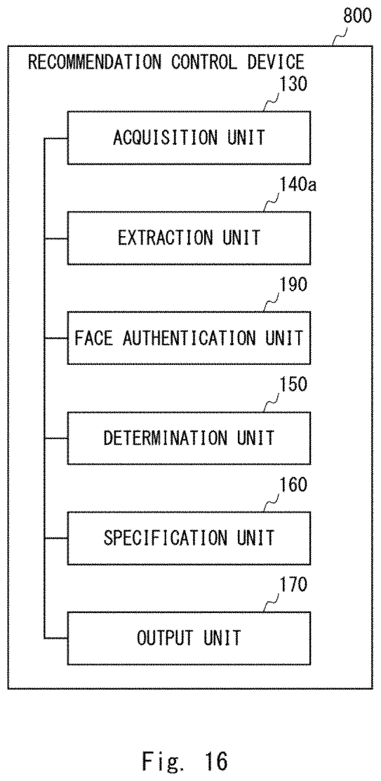

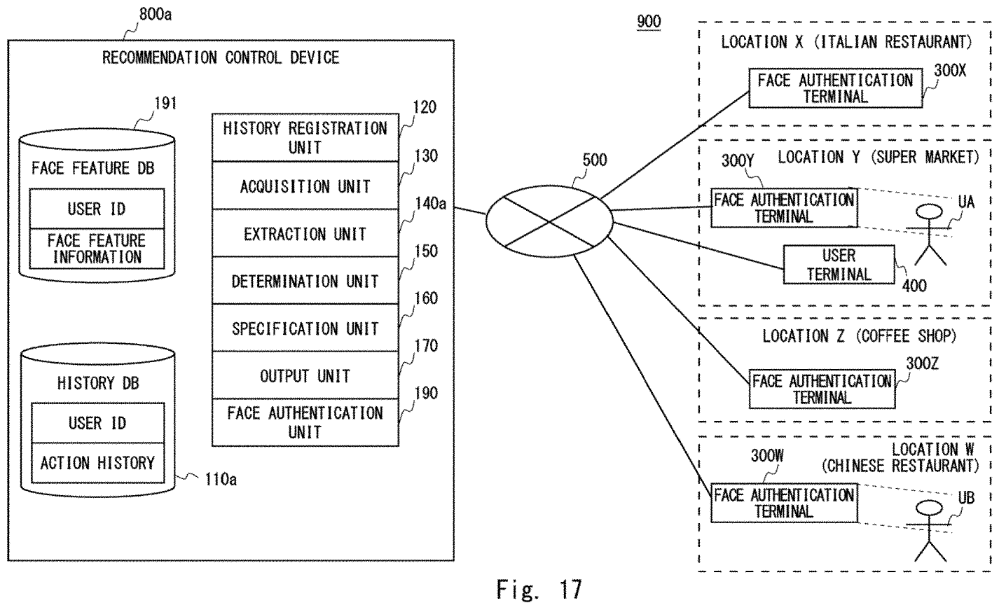

FIG. 16 is a block diagram illustrating a configuration of the recommendation control device according to the third example embodiment. As compared to the configuration of the recommendation control device 100 illustrated in FIG. 1, the recommendation control device 800 is acquired by replacing the authentication control unit 140 with an extraction unit 140a and a face authentication unit 190 and adding a face feature DB 191 (not illustrated). Note that the face feature DB 191 is one example of a face feature information storage unit. Description for each of the configurations included in the recommendation control device 800, which overlaps with the second example embodiment, is omitted as appropriate. FIG. 17 is a block diagram illustrating a configuration of a recommendation control system according to the third example embodiment. A recommendation control system 900 is different from the recommendation control system 600 in that the authentication device 200 is not included and the recommendation control device 800a is included. Other configurations thereof are similar, and hence description therefor is omitted as appropriate.

The extraction unit 140a extracts the face region or the face feature information from the captured image. The face authentication unit 190 executes face authentication, based on the extracted face region or face feature information. The face feature DB 191 is a face feature database that stores the user ID and the face feature information of the user in association with each other. Similarly to the recommendation control device 100, the recommendation control device 800a controls provision of the recommendation information by following the flow illustrated in FIG. 2. However, in Step S103, the extraction unit 140a extracts the face region or the face feature information from the captured image acquired by the acquisition unit 130, and the face authentication unit 190 executes face authentication, based on the extracted face region or face feature information. Moreover, the recommendation control device according to the present example embodiment can exert effects similar to the effects described in the first example embodiment and the second example embodiment.

Note that the above-mentioned example embodiment is described as a hardware configuration, but is not limited thereto. The present disclosure can be achieved by causing a CPU to execute a computer program for freely-selected processing.

In the above-described examples, the program can be stored using a non-transitory computer-readable medium of various types, and can be supplied to the computer. Examples of the non-transitory computer-readable medium include a tangible storage medium of various types. Examples of the non-transitory computer-readable medium include a magnetic recording medium (for example, a flexible disk, a magnetic tape, and a hard disk drive), a magneto-optical recording medium (for example, a magneto-optical disk), a CD Read Only Memory (ROM), a CD-R, a CD-R/W, a Digital Versatile Disc (DVD), a semiconductor memory (for example, a mask ROM, a Programmable ROM (PROM), an Erasable PROM (EPROM), a flash ROM, and a Random Access Memory (RAM)). Further, the program may be supplied to the computer by a transitory computer-readable medium of various types. Examples of the transitory computer-readable medium include an electric signal, an optical signal, and an electromagnetic wave. The transitory computer-readable medium can supply the program to the computer via a wired communication path such as a wire and an optical fiber or a wireless communication path.

Note that the present disclosure is not limited to the example embodiments described above, and can be modified as appropriate without departing from the basic technical idea. Further, the present disclosure may be implemented by combining the example embodiments with each other as appropriate.

The whole or a part of the example embodiments described above can be described as, but not limited to, the following supplementary notes.

### (Supplementary Note A1)

A recommendation control device comprising:
acquisition unit for acquiring a captured image photographed by a predetermined photographing device;
authentication control unit for extracting a face region or face feature information from the captured image and causing an authentication device to execute face authentication;
determination unit for determining whether an action history of a first user who succeeds in the face authentication shows a predetermined tendency;
specification unit for specifying a second user having at least one of an action history and an attribute that is similar to those of the first user when it is determined that the predetermined tendency is shown, and specifying recommendation information, based on a part of an action history of the second user, the part not overlapping with the action history of the first user; and
output unit for transmitting, to a predetermined display terminal, the recommendation information specified by the specification means.

### (Supplementary Note A2)

The recommendation control device according to Supplementary Note A1, wherein
the action history further includes a purchase history of the first user,
the predetermined tendency includes a fact that the first user purchases a specific product a plurality of times, and
the specification unit specifies, as the second user, another user who purchases the specific product a plurality of times.

### (Supplementary Note A3)

The recommendation control device according to Supplementary Note A1 or A2, wherein, when the determination means determines that the action history of the first user shows a predetermined tendency, the specification unit specifies a second user with an action history showing the predetermined tendency, and specifies the recommendation information, based on an action history that does not show the predetermined tendency in an action history of the second user.

### (Supplementary Note A4)

The recommendation control device according to any one of Supplementary Note A1 to A3, further comprising:
history storage unit for storing an action history of a plurality of users; and
history registration unit for registering, in the history storage unit, a user ID and an action history in association with each other,
wherein the determination unit acquires, from the history storage unit, an action history associated with a user ID of a first user who succeeds in the face authentication, and determines whether the action history shows a predetermined tendency.

### (Supplementary Note A5)

The recommendation control device according to Supplementary Note A4, wherein
the history registration unit registers, in the history storage unit, a user ID and an action history, and an attribute of the user in association with each other,
the first tendency includes an attribute of the first user, and
the specification unit specifies a user having the attribute as the second user.

### (Supplementary Note A6)

The recommendation control device according to any one of Supplementary Note A1 to A5, wherein the specification unit specifies recommendation information in response to a request from a user.

### (Supplementary Note B1)

A recommendation control system comprising:
a photographing device configured to capture an image including a face region of a user;
an authentication device configured to store face feature information about the user; and
a recommendation control device being connected to the photographing device and the authentication device,
wherein the recommendation control system further includes:
   acquisition unit for acquiring a captured image photographed by the photographing device;
   authentication control unit for extracting a face region or face feature information from the captured image and causing an authentication device to execute face authentication;
   determination unit for determining whether an action history of a first user who succeeds in the face authentication shows a predetermined tendency;
   specification unit for specifying a second user having at least one of an action history and an attribute that is similar to those of the first user when it is determined that the predetermined tendency is shown, and specifying recommendation information, based on a part of an action history of the second user, the part not overlapping with the action history of the first user; and
   output unit for transmitting, to a predetermined display terminal, the recommendation information specified by the specification unit.

### (Supplementary Note B2)

The recommendation control system according to Supplementary Note B1, wherein
the action history further includes a purchase history of the first user,
the predetermined tendency includes a fact that the first user purchases a specific product a plurality of times, and
the specification unit specifies, as the second user, another user who purchases the specific product a plurality of times.

### (Supplementary Note C1)

A recommendation control method comprising, by a computer:
a step of acquiring a captured image photographed by a predetermined photographing device;
a step of extracting a face region or face feature information from the captured image and causing an authentication device to execute face authentication;
a step of determining whether an action history of a first user who succeeds in the face authentication shows a predetermined tendency;
a step of specifying a second user having at least one of an action history and an attribute that is similar to those of the first user when it is determined that the predetermined tendency is shown, and specifying recommendation information, based on a part of an action history of the second user, the part not overlapping with the action history of the first user; and
a step of transmitting, to a predetermined display terminal, the recommendation information that is specified.

### (Supplementary Note D1)

A non-transitory computer-readable medium configured to store a recommendation control program causing a computer to execute:
a step of acquiring a captured image photographed by a predetermined photographing device;
a step of extracting a face region or face feature information from the captured image and causing an authentication device to execute face authentication;
a step of determining whether an action history of a first user who succeeds in the face authentication shows a predetermined tendency;
a step of specifying a second user having at least one of an action history and an attribute that is similar to those of the first user when it is determined that the predetermined tendency is shown, and specifying recommendation information, based on a part of an action history of the second user, the part not overlapping with the action history of the first user; and
a step of transmitting, to a predetermined display terminal, the recommendation information that is specified.

### (Supplementary Note E1)

A recommendation control device comprising:
acquisition unit for acquiring a captured image photographed by a predetermined photographing device;
extraction unit for extracting a face region or face feature information from the captured image;
face authentication means for executing face authentication, based on the face region or the face feature information;
determination unit for determining whether an action history of a first user who succeeds in the face authentication shows a predetermined tendency;
specification unit for specifying a second user having at least one of an action history and an attribute that is similar to those of the first user when it is determined that the predetermined tendency is shown, and specifying recommendation information, based on a part of an action history of the second user, the part not overlapping with the action history of the first user; and
output unit for transmitting, to a predetermined display terminal, the recommendation information specified by the specification unit.

### (Supplementary Note E2)

The recommendation control device according to Supplementary Note E1, wherein
the action history further includes a purchase history of the first user,
the predetermined tendency includes a fact that the first user purchases a specific product a plurality of times, and
the specification unit specifies, as the second user, another user who purchases the specific product a plurality of times.

### (Supplementary Note F1)

A recommendation control method comprising, by a computer:
a step of acquiring a captured image photographed by a predetermined photographing device;
a step of extracting a face region or face feature information from the captured image;
a step of executing face authentication, based on the face region or the face feature information;
a step of determining whether an action history of a first user who succeeds in the face authentication shows a predetermined tendency;
a step of specifying a second user having at least one of an action history and an attribute that is similar to those of the first user when it is determined that the predetermined tendency is shown, and specifying recommendation information, based on a part of an action history of the second user, the part not overlapping with the action history of the first user; and
a step of transmitting, to a predetermined display terminal, the recommendation information that is specified.

### (Supplementary Note G1)

A non-transitory computer-readable medium configured to store a recommendation control program causing a computer to execute:
a step of acquiring a captured image photographed by a predetermined photographing device;
a step of extracting a face region or face feature information from the captured image;
a step of executing face authentication, based on the face region or the face feature information;
a step of determining whether an action history of a first user who succeeds in the face authentication shows a predetermined tendency;
a step of specifying a second user having at least one of an action history and an attribute that is similar to those of the first user when it is determined that the predetermined tendency is shown, and specifying recommendation information, based on a part of an action history of the second user, the part not overlapping with the action history of the first user; and
a step of transmitting, to a predetermined display terminal, the recommendation information that is specified.

While the invention of the present application has been particularly described with reference to the example embodiments (and the examples) thereof, the invention of the present application is not limited to these example embodiments (and the examples) described above. Various modifications that can be understood by a person skilled in the art can be made to the configurations and the details of the invention of the present application, within the scope of the invention of the present application.

### REFERENCE SIGNS LIST

100, 100a, 800, 800a RECOMMENDATION CONTROL DEVICE
600, 900 RECOMMENDATION CONTROL SYSTEM
110a HISTORY DB
120 HISTORY REGISTRATION UNIT
130 ACQUISITION UNIT
140 AUTHENTICATION CONTROL UNIT
140a EXTRACTION UNIT
150 DETERMINATION UNIT
160 SPECIFICATION UNIT
170 OUTPUT UNIT
190 FACE AUTHENTICATION UNIT
191 FACE FEATURE DB
200 AUTHENTICATION DEVICE
210 FACE FEATURE DB
220 FACE DETECTION UNIT
230 FEATURE POINT EXTRACTION UNIT
240 REGISTRATION UNIT
250 AUTHENTICATION UNIT
300 (300X to 300W) FACE AUTHENTICATION TERMINAL
310 CAMERA
320 CONTROL UNIT
322 PHOTOGRAPHING REQUEST UNIT
323 FACE FEATURE INFORMATION REGISTRATION REQUEST UNIT
324 AUTHENTICATION REQUEST UNIT
325 PAYMENT PROCESSING UNIT
326 HISTORY REGISTRATION REQUEST UNIT
327 CHANGE RECOMMENDATION REQUEST UNIT
330 STORAGE UNIT
340 COMMUNICATION UNIT
350 DISPLAY UNIT
400 USER TERMINAL
410 CAMERA
420 CONTROL UNIT
422 PHOTOGRAPHING REQUEST UNIT
423 FACE FEATURE INFORMATION REGISTRATION REQUEST UNIT
424 AUTHENTICATION REQUEST UNIT
425 PAYMENT PROCESSING UNIT
426 HISTORY REGISTRATION REQUEST UNIT
427 CHANGE RECOMMENDATION REQUEST UNIT
430 STORAGE UNIT
440 COMMUNICATION UNIT
450 DISPLAY UNIT
500 NETWORK

1. A recommendation control device comprising:
acquisition means for acquiring a captured image photographed by a predetermined photographing device;
authentication control means for extracting a face region or face feature information from the captured image and causing an authentication device to execute face authentication;
determination means for determining whether an action history of a first user who succeeds in the face authentication shows a predetermined tendency;
specification means for specifying a second user having at least one of an action history and an attribute that is similar to those of the first user when it is determined that the predetermined tendency is shown, and specifying recommendation information, based on a part of an action history of the second user, the part not overlapping with the action history of the first user; and
output means for transmitting, to a predetermined display terminal, the recommendation information specified by the specification means.

2. The recommendation control device according to claim 1, wherein
the action history further includes a purchase history of the first user,
the predetermined tendency includes a fact that the first user purchases a specific product a plurality of times, and
the specification means specifies, as the second user, another user who purchases the specific product a plurality of times.

3. The recommendation control device according to claim 1 or 2, wherein, when the determination means determines that the action history of the first user shows a predetermined tendency, the specification means specifies a second user with an action history showing the predetermined tendency, and specifies the recommendation information, based on an action history that does not show the predetermined tendency in an action history of the second user.

4. The recommendation control device according to any one of claims 1 to 3, further comprising:
history storage means for storing an action history of a plurality of users; and
history registration means for registering, in the history storage means, a user ID and an action history in association with each other,
wherein the determination means acquires, from the history storage means, an action history associated with a user ID of a first user who succeeds in the face authentication, and determines whether the action history shows a predetermined tendency.

5. The recommendation control device according to claim 4, wherein
the history registration means registers, in the history storage means, a user ID and an action history, and an attribute of the user in association with each other,
the first tendency includes an attribute of the first user, and
the specification means specifies a user having the attribute as the second user.

6. The recommendation control device according to any one of claims 1 to 5, wherein the specification means specifies recommendation information in response to a request from a user.

7. A recommendation control system comprising:
a photographing device configured to capture an image including a face region of a user;
an authentication device configured to store face feature information about the user; and
a recommendation control device being connected to the photographing device and the authentication device,
wherein the recommendation control system further includes:
acquisition means for acquiring a captured image photographed by the photographing device;
authentication control means for extracting a face region or face feature information from the captured image and causing an authentication device to execute face authentication;
determination means for determining whether an action history of a first user who succeeds in the face authentication shows a predetermined tendency;
specification means for specifying a second user having at least one of an action history and an attribute that is similar to those of the first user when it is determined that the predetermined tendency is shown, and specifying recommendation information, based on a part of an action history of the second user, the part not overlapping with the action history of the first user; and
output means for transmitting, to a predetermined display terminal, the recommendation information specified by the specification means.

8. The recommendation control system according to claim 7, wherein
the action history further includes a purchase history of the first user,
the predetermined tendency includes a fact that the first user purchases a specific product a plurality of times, and
the specification means specifies, as the second user, another user who purchases the specific product a plurality of times.

9. A recommendation control method comprising, by a computer:
a step of acquiring a captured image photographed by a predetermined photographing device;
a step of extracting a face region or face feature information from the captured image and causing an authentication device to execute face authentication;
a step of determining whether an action history of a first user who succeeds in the face authentication shows a predetermined tendency;
a step of specifying a second user having at least one of an action history and an attribute that is similar to those of the first user when it is determined that the predetermined tendency is shown, and specifying recommendation information, based on a part of an action history of the second user, the part not overlapping with the action history of the first user; and
a step of transmitting, to a predetermined display terminal, the recommendation information that is specified.

10. A non-transitory computer-readable medium configured to store a recommendation control program causing a computer to execute:
a step of acquiring a captured image photographed by a predetermined photographing device;
a step of extracting a face region or face feature information from the captured image and causing an authentication device to execute face authentication;
a step of determining whether an action history of a first user who succeeds in the face authentication shows a predetermined tendency;
a step of specifying a second user having at least one of an action history and an attribute that is similar to those of the first user when it is determined that the predetermined tendency is shown, and specifying recommendation information, based on a part of an action history of the second user, the part not overlapping with the action history of the first user; and
a step of transmitting, to a predetermined display terminal, the recommendation information that is specified.

11. A recommendation control device comprising:
acquisition means for acquiring a captured image photographed by a predetermined photographing device;
extraction means for extracting a face region or face feature information from the captured image;
face authentication means for executing face authentication, based on the face region or the face feature information;
determination means for determining whether an action history of a first user who succeeds in the face authentication shows a predetermined tendency;
specification means for specifying a second user having at least one of an action history and an attribute that is similar to those of the first user when it is determined that the predetermined tendency is shown, and specifying recommendation information, based on a part of an action history of the second user, the part not overlapping with the action history of the first user; and
output means for transmitting, to a predetermined display terminal, the recommendation information specified by the specification means.

12. The recommendation control device according to claim 11, wherein
the action history further includes a purchase history of the first user,
the predetermined tendency includes a fact that the first user purchases a specific product a plurality of times, and
the specification means specifies, as the second user, another user who purchases the specific product a plurality of times.

13. A recommendation control method comprising, by a computer:
a step of acquiring a captured image photographed by a predetermined photographing device;
a step of extracting a face region or face feature information from the captured image;
a step of executing face authentication, based on the face region or the face feature information;
a step of determining whether an action history of a first user who succeeds in the face authentication shows a predetermined tendency;
a step of specifying a second user having at least one of an action history and an attribute that is similar to those of the first user when it is determined that the predetermined tendency is shown, and specifying recommendation information, based on a part of an action history of the second user, the part not overlapping with the action history of the first user; and
a step of transmitting, to a predetermined display terminal, the recommendation information that is specified.

14. A non-transitory computer-readable medium configured to store a recommendation control program causing a computer to execute:
a step of acquiring a captured image photographed by a predetermined photographing device;
a step of extracting a face region or face feature information from the captured image;
a step of executing face authentication, based on the face region or the face feature information;
a step of determining whether an action history of a first user who succeeds in the face authentication shows a predetermined tendency;
a step of specifying a second user having at least one of an action history and an attribute that is similar to those of the first user when it is determined that the predetermined tendency is shown, and specifying recommendation information, based on a part of an action history of the second user, the part not overlapping with the action history of the first user; and
a step of transmitting, to a predetermined display terminal, the recommendation information that is specified.
